(19) United States
(12) Patent Application Publication
(10) Pub. No.: US 2026/0181614 A1
(43) Pub. Date: Jun. 25, 2026

(54) METHODS, ARCHITECTURES, APPARATUSES AND SYSTEMS FOR INITIATING COMMUNICATIONS IN A WIRELESS COMMUNICATIONS NETWORK

(71) Applicant: InterDigital Patent Holdings, Inc., Wilmington, DE (US)

(72) Inventors: Moon IL Lee, Melville, NY (US); Paul Marinier, Brossard (CA); Ghyslain Pelletier, Montreal (CA)

(21) Appl. No.: 18/990,970

(22) Filed: Dec. 20, 2024

(51) Int. Cl. H04W 72/0453; H04W 48/18

(52) U.S. Cl. CPC H04W 72/0453; H04W 48/18

(57) ABSTRACT

Procedures, methods, architectures, apparatuses, systems, devices, and computer program products for initiating communication in a wireless communications network are disclosed. A plurality of channel raster groups may be defined in the communications network system. Devices in the wireless communications system may select a channel raster group in dependence on a system characteristic accessible to the devices. The system characteristic may be a network-sided characteristic or a WTRU-sided characteristic. A WTRU may send or seek signals in the frequencies in a selected channel raster group rather than sending or seeking signals in the larger number of frequencies in the plurality of channel raster groups.

### BACKGROUND

The present disclosure is generally directed to the fields of communications, software and encoding, including, for example, to methods, architectures, apparatuses, systems related to initiating communications in a wireless communications network.

To avoid the need for a Wireless Transmit/Receive Unit (WTRU) to scan continuously across the range of frequencies used by the wireless communications network in order to initiate communications with the wireless communications network, some wireless communications networks restrict the possible frequencies on which an communication initialization signal is sent to a predetermined discrete set of frequencies. Such a predetermined discrete set of frequencies may be referred to as a raster, and a raster for initialization signals is known as a synchronization raster.

Consumers are increasingly expecting Wireless Transmit/Receive Units (WTRUs) to operate over a variety of radio access technologies, and growing demand for communication capacity is pushing radio access technologies into higher frequency ranges. This presents a challenge for WTRU designers in that, even when restricted to a predetermined synchronization raster, on initial access to a network, WTRUs are having to devote an increasing amount of resource to identifying the frequency in the synchronization raster chosen by the network before being able to access the network.

### SUMMARY

According to the present disclosure, a wireless communication system may utilize different channel raster groups depending on system characteristics known to network entities in the wireless communications system. The system characteristics may be network-sided characteristics or WTRU-sided characteristics. The WTRU may select a channel raster group based on a system characteristic known to both the WTRU and a network entity which the WTRU is attempting to access. The selection of a channel raster group may narrow the number of frequencies which need to be searched by the WTRU in initially accessing a wireless communications network. The WTRU may select a frequency from the selected channel raster group, and handle the signal on the selected frequency.

The WTRU may convey information to other network entities by selecting a channel raster group for transmission of a signal. Similarly, a network entity may convey information to a WTRU by selecting a channel raster group for a signal.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a table showing a subset of new radio (NR) operating bands in frequency range 1 (FR1);

FIG. 3 is a table showing available channel bandwidths for a subset of new radio (NR) operating bands in frequency range 1 (FR1);

FIG. 4 is a table showing NR absolute radio frequency channel number (NR-ARFCN) parameters for a global frequency raster for new radio frequency ranges;

FIG. 5A is a table showing a synchronization raster for channel bandwidths above 3 MHz;

FIG. 5B is a table showing a synchronization raster for channel bandwidths of 3 MHz;

FIG. 6 is a table showing a synchronization raster in terms of Global Synchronization Channel Number (GSCN) values for a subset of new radio (NR) operating bands in frequency range 1 (FR1);

FIG. 7 is a table showing a synchronization raster in terms of Global Synchronization Channel Number (GSCN) values for new radio (NR) operating bands in frequency range 1 (FR1) for which a 3 MHz channel bandwidth is available;

FIG. 8 is a table showing a synchronization raster in terms of Global Synchronization Channel Number (GSCN) values for new radio (NR) operating bands in frequency range 1 (FR2);

FIG. 9 is a schematic illustration of correspondence between different raster types;

FIG. 10 depicts different channel raster groups and their correspondence to a global channel raster; and

FIG. 11 illustrates the operation of a WTRU according to a representative embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

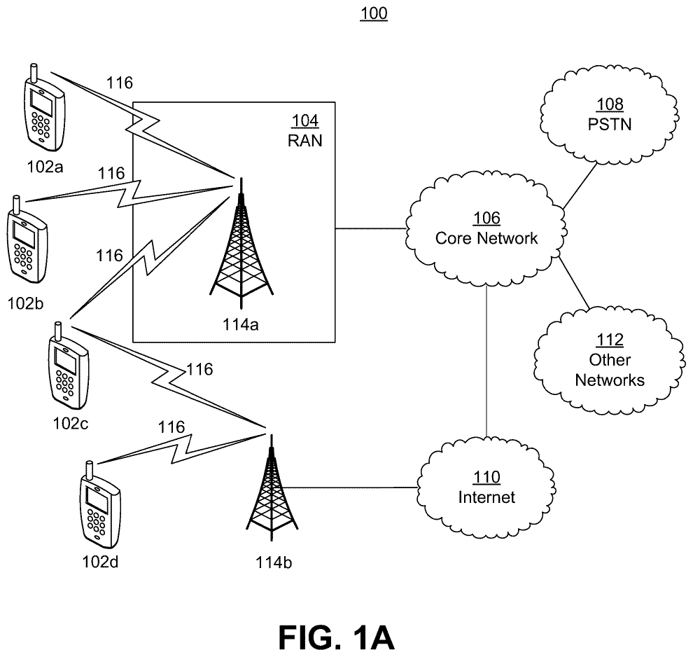

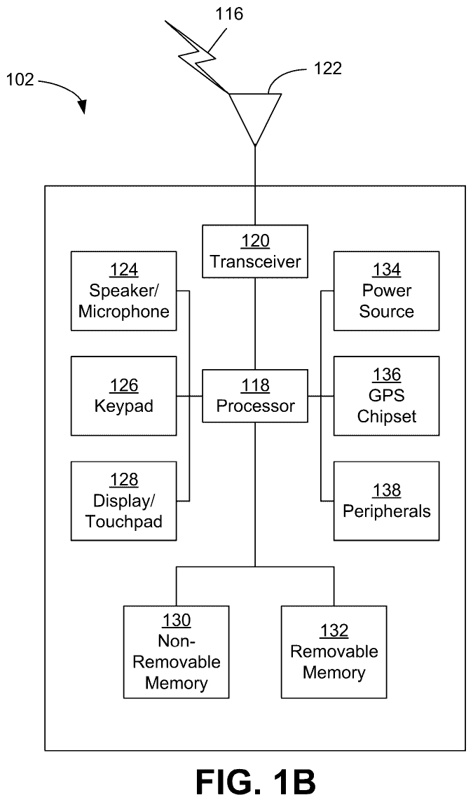

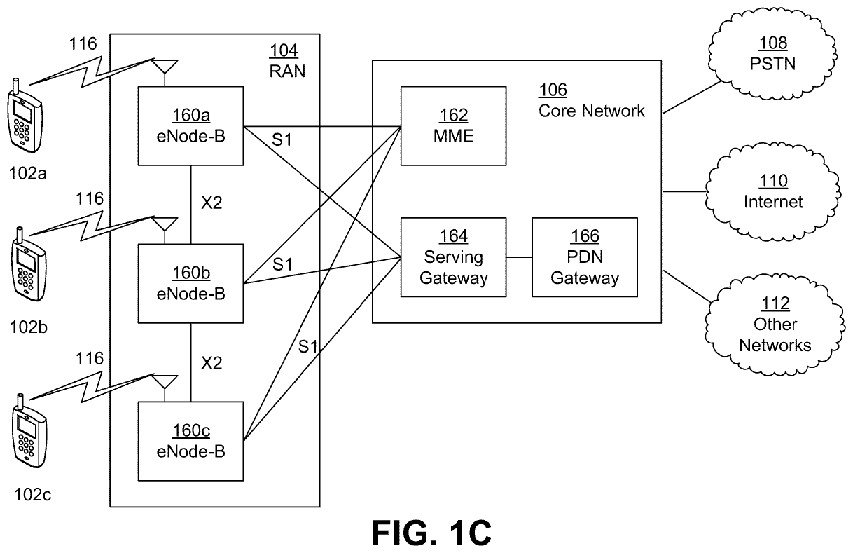

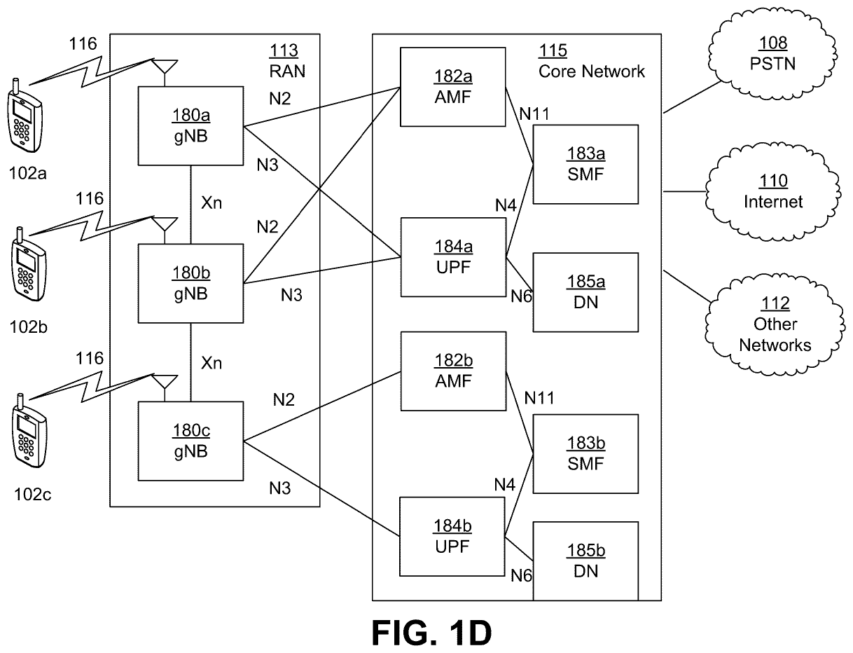

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114 a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102 a, 102 b, 102 c, 102 d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

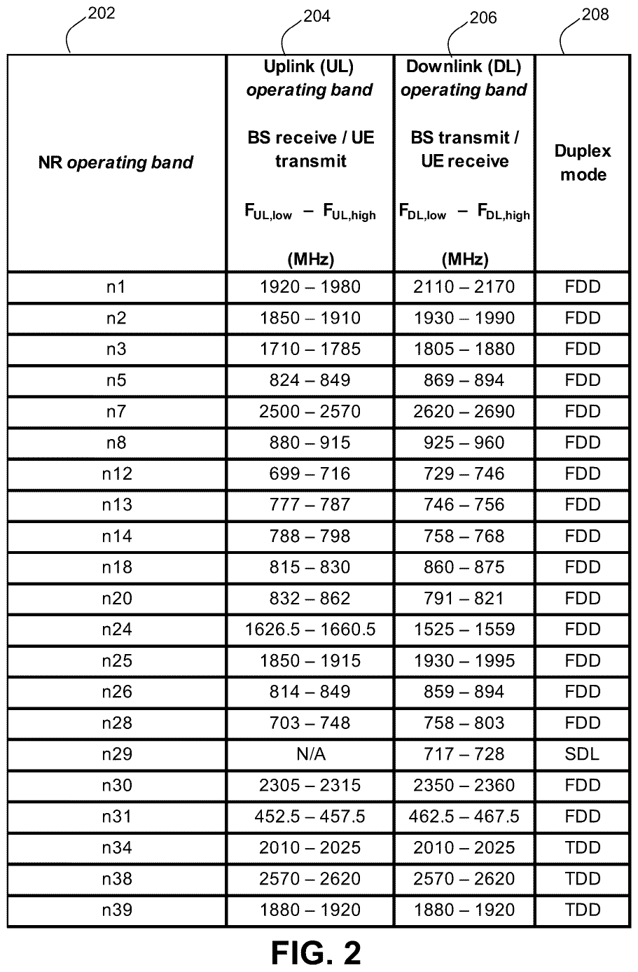

In some approaches, wireless spectrum is sub-divided into frequency ranges in order to administer its use. For example, two frequency ranges are defined for use in NR RANs, a lower frequency range (FR1) between 410 MHz and 7.125 GHz, and an upper frequency range (FR2) between 24.25 GHz and 52.6 GHz. Operating frequency bands may be specified within frequency ranges. For example, as illustrated in FIG. 2, in NR RANs, a number of operating frequency bands are specified within FR1 (only some of the operating frequency bands are seen in FIG. 2). Each operating frequency band may have an associated identity 202 (e.g., index, number), a portion of frequency spectrum 204, 206 (e.g., specified by a starting frequency and an ending frequency) of Uplink and/or Downlink, and a duplex mode 208. For some operating frequency bands, for supplementary downlink (SDL) or supplementary uplink (SUL), only an operating frequency band for Downlink or Uplink is defined (e.g., n29).

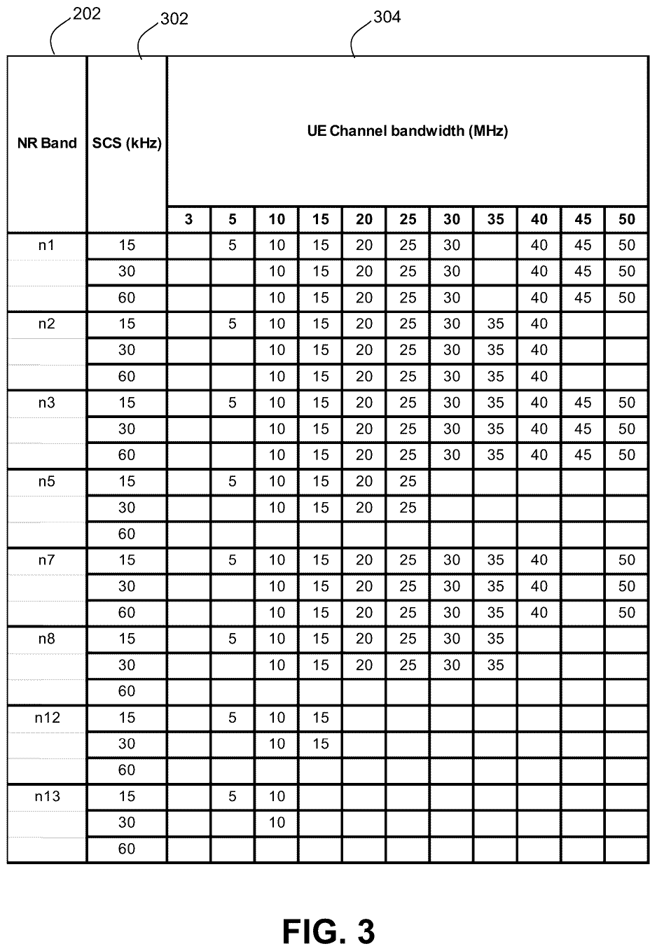

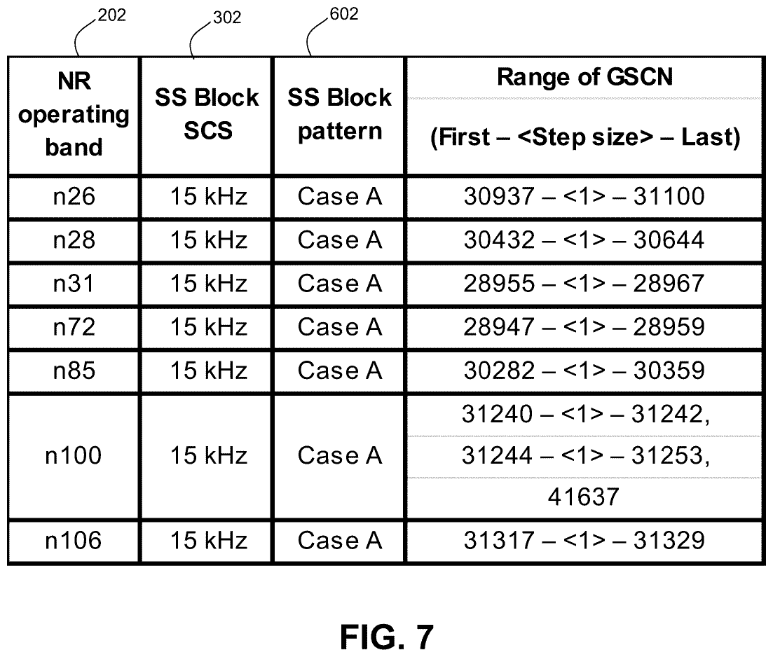

As illustrated in the table of FIG. 3 (which covers the first eight operating frequency bands seen in FIG. 2), for each of the operating frequency bands 202, one or more subcarrier spacings (SCS) may be defined, and for each subcarrier spacing in each operating frequency band, one or more supported WTRU channel bandwidths 304 may be supported. As will be discussed below in relation to FIG. 7, some operating frequency bands 202 may support a 3 MHz channel bandwidth.

Herein, a NR operating band may be interchangeably used with an operating frequency band, a NR operating frequency band, a 6G operating band, a new radio access technology (RAT) operating band, a multi-RAT spectrum sharing (MRSS) operating band, etc. A NR operating band number may be interchangeably used with an operating frequency band number, an operating frequency band identity, a NR operating band identity, etc.

Herein, a WTRU channel bandwidth may be interchangeably used with channel bandwidth (CB), and CB.

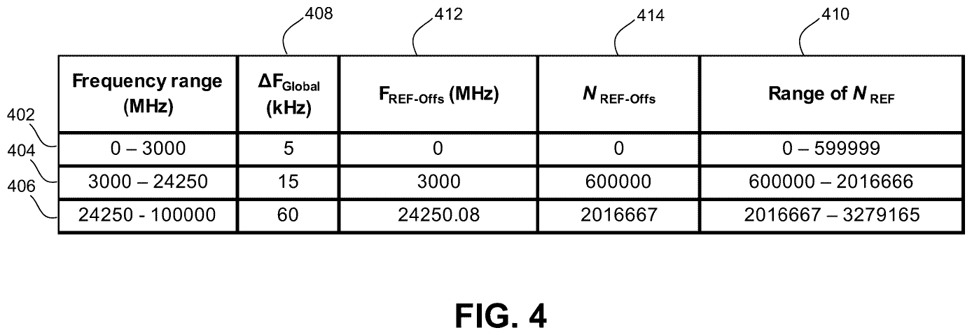

With reference to FIG. 4, in NR RANs, a global frequency raster may comprise a set of radio frequency (RF) reference frequencies (F_{REF}). A reference frequency may be used in signaling to identify a position of one or more RF channels, synchronization signal (SS) blocks and other elements. FIG. 4 shows how a global frequency raster may be defined for all frequencies from 0 to 100 GHz. The global frequency raster may have different granularities in different frequency ranges (for example, a coarser granularity may be set for higher frequency ranges). Hence, in the example illustrated in FIG. 4, in first frequency range 402 (e.g., 0 to 3 GHz) a granularity 408 of the global frequency raster (ΔF_{Global}) may be set to 5 kHz, in a second frequency range 404 (e.g., 3 GHz to 24.25 GHz (the latter frequency being the lower bound of FR2)) a granularity 408 of the global frequency raster (ΔF_{Global}) may be set to 15 kHz, in a third frequency range 406 (e.g., 24.25 GHz to 100 GHz) a granularity 408 of the global frequency raster (ΔF_{Global}) may be set to 60 kHz.

Reference frequencies in a raster may be designated by a number (N_{REF}) 410. For example, in NR RANs, each reference frequency in the global frequency raster is associated with a NR-Absolute Radio Frequency Channel Number (NR-ARFCN) in the range [0 . . . 3,279,165]. A reference frequency can then be calculated from the number (N_{REF}). For example, in NR RANs, the relation between the NR-ARFCN and F_{REF} in MHz is given by the equation below, wherein F_{REF-Offs} 412 is an offset frequency defined for each frequency band, and N_{REF-Offs} 414 is an offset number defined for each frequency band.

$${F}_{REF} = {F}_{REF - Offs} + Δ {F}_{Global} ( {N}_{REF} - {N}_{REF - Offs} )$$

A channel raster may define a subset of the reference frequencies in a global frequency raster that can be used to identify a RF channel position in the uplink and downlink. For each frequency range, a subset of frequencies from the global frequency raster may be applicable, and may form a channel raster with a granularity ΔF_{Raster}, which may be, e.g., equal to or larger than ΔF_{Global}.

A reference frequency for an RF channel may map to a resource element on a carrier.

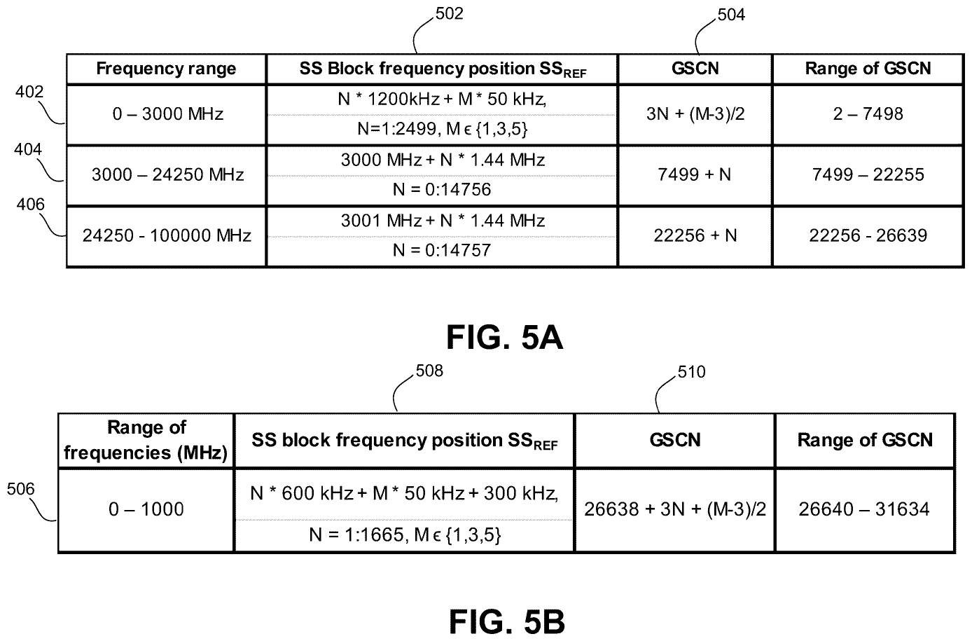

A synchronization raster may also be defined. For example, in FIG. 5A, formulae 502 are given for calculating reference frequencies in a first example synchronization raster from number N, and, in the case of frequency range 402, a second number M. A unique synchronization raster number (e.g, a Global Synchronization Channel Number (GSCN)) may be similarly obtained from numbers N and M using a formula 504. The synchronization raster step size may be 1200 kHz for a first frequency range (0-3000 MHz), 1.44 MHz for a second frequency range (3000-24250 MHz), and 17.28 MHz for a third frequency range (24250-100000 MHz). The first example synchronization raster (FIG. 5A) may be applied, for example, to channel bandwidths (FIGS. 3, 304) above 3 MHz.

A second example of a synchronization raster is shown in FIG. 5B. As with the first synchronization raster (FIG. 5A), reference frequencies in the synchronization raster can be calculated from one or more numbers N, M using a formula (508), and a GSCN can be calculated from the same numbers using another formula 510. The formulae 504, 506 may be chosen so that both the first and second channel rasters are included in a contiguous range of GSCNs. The second example synchronization raster (FIG. 5B) may be applied, for example, to channel bandwidths (FIGS. 3, 304) of 3 MHz.

A frequency position of a synchronization block (e.g., hereinafter referred to as a SS block, a synchronization signal/physical broadcast channel (SS/PBCH) block, synchronization signal block (SSB)) may be used, by the WTRU, for system acquisition when an explicit signaling of the SSB position is absent.

Herein, a Synchronization raster may be interchangeably used with a Sync raster, a SSB raster, a SS/PBCH block raster, a frequency raster for synchronization signal reception, a frequency raster for initial cell search, etc.

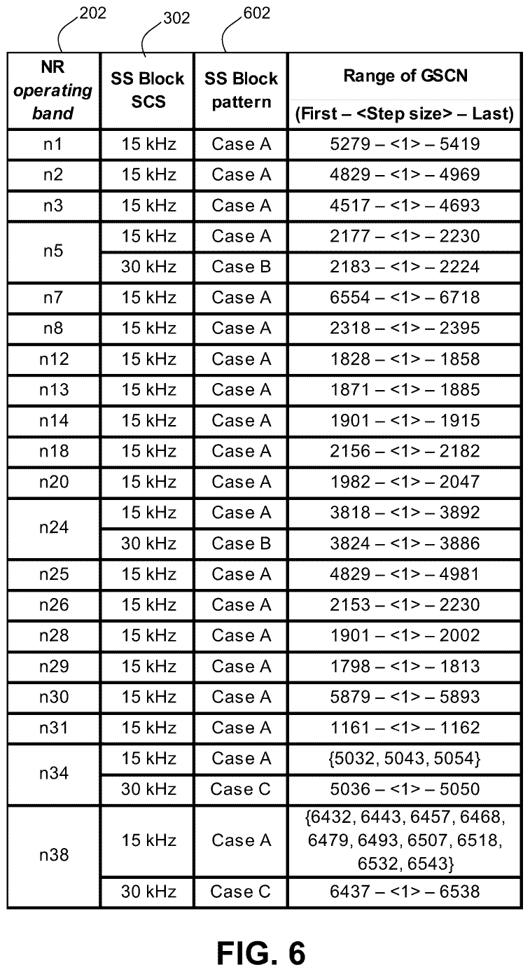

FIG. 6 illustrates a synchronization raster for each operating band in FR1 for channel bandwidths above 3 MHz. FIG. 6 illustrates how the Global Synchronization Channel Numbers of the first example synchronization raster of FIG. 5A map onto the NR operating frequency bands of FIG. 2=For each SCS 302 in each operating frequency band 202, a distance between applicable GSCN entries may be provided by a ‘<Step size>’.

A SS Block pattern 602 may refer to as starting symbol locations of one or more SS Blocks transmitted in a half frame. For a half frame with SS/PBCH blocks, first symbol indexes for candidate SS/PBCH blocks may be determined according to a subcarrier spacing of SS/PBCH blocks as follows:
Case A—15 kHz subcarrier spacing: the first symbols of the candidate SS/PBCH blocks may have indexes of {2, 8}+14*n. For carrier frequencies smaller than or equal to 3 GHz, n=0, 1. For carrier frequencies larger than 3 GHz and smaller than or equal to 6 GHz, n=0, 1, 2, 3.
Case B—30 kHz subcarrier spacing: the first symbols of the candidate SS/PBCH blocks may have indexes {4, 8, 16, 20}+28*n. For carrier frequencies smaller than or equal to 3 GHz, n=0. For carrier frequencies larger than 3 GHz and smaller than or equal to 6 GHz, n=0, 1.
Case C—30 kHz subcarrier spacing: the first symbols of the candidate SS/PBCH blocks may have indexes {2, 8}+14*n. For carrier frequencies smaller than or equal to 3 GHz, n=0, 1. For carrier frequencies larger than 3 GHz and smaller than or equal to 6 GHz, n=0, 1, 2, 3.
Case D—120 kHz subcarrier spacing: the first symbols of the candidate SS/PBCH blocks may have indexes {4, 8, 16, 20}+28*n. For carrier frequencies larger than 6 GHz, n=0, 1, 2, 3, 5, 6, 7, 8, 10, 11, 12, 13, 15, 16, 17, 18.
Case E—240 kHz subcarrier spacing: the first symbols of the candidate SS/PBCH blocks may have indexes {8, 12, 16, 20, 32, 36, 40, 44}+56*n. For carrier frequencies larger than 6 GHz, n=0, 1, 2, 3, 5, 6, 7, 8.

FIG. 7 illustrates a synchronization raster for each operating band in FR1 for channel bandwidths of 3 MHz. FIG. 7 illustrates how the Global Synchronization Channel Numbers of the second example synchronization raster of FIG. 5B map onto the NR operating frequency bands in FR1 (some of which are shown in FIG. 2). The ranges of GSCN seen in FIG. 5B encompass the ranges of GSCN for each operating band in FIG. 7 As with FIG. 6, for each SCS 302 in each operating frequency band 202, a distance between applicable GSCN entries may be provided by a ‘<Step size>’.

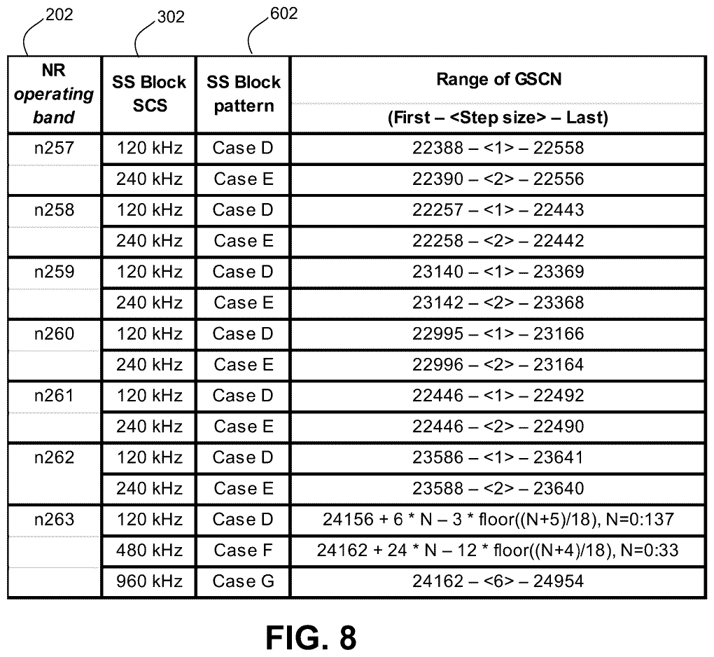

FIG. 8 illustrates a synchronization raster for some operating bands in FR2. FIG. 7 illustrates how the Global Synchronization Channel Numbers of the second example synchronization raster of FIG. 5A (third row) map onto the NR operating frequency bands in FR2. As with FIG. 6 and FIG. 7, for each SCS 302 in each operating frequency band 202, a distance between applicable GSCN entries may be provided by a ‘<Step size>’. In this case, step sizes greater than one are seen.

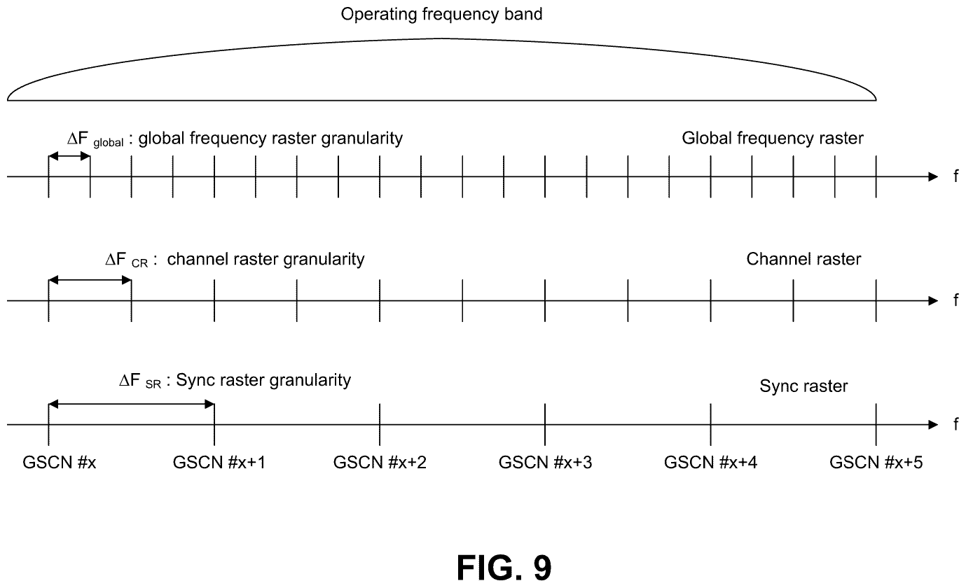

As shown in FIG. 9, a global frequency raster may be a reference frequency location used for other types of rasters. A channel raster may be reference frequencies where physical channels or signals may be transmitted, wherein the channel raster may be a subset of global frequency raster or equivalent to the global frequency raster. A subset of channel rasters may be used, defined, or determined as a Sync raster, where a SS Block signal may be transmitted. Each frequency in a Sync raster may be associated with a respective GSCN number.

In the approaches described above, a Sync raster step size may have been defined per frequency range without consideration of other aspects. When a bandwidth of an operating frequency band is relatively large, a WTRU may still be required to scan an excessive number of Sync raster candidates to detect a SSB during an initial cell search. For example, a 1.4 MHz Sync raster step size requires 72 scans for 100 MHz frequency bandwidth for a certain operating frequency band. If a WTRU needs to search multiple operating frequency bands, the complexity of the initial cell search is further increased. Excessive WTRU energy is thus consumed for cell search. Additionally, a WTRU may need to first detect an SSB and read the system information to figure out whether a cell supports the type of the WTRU. A network may bar one or more types of WTRUs to avoid the situation where low-capability WTRUs consume most of the network resources as an example. Therefore, the WTRU may only know after successfully receiving an SSB and the system information whether the cell supports the type (e.g., capability, category) of the WTRU and whether the WTRU can camp on the cell. If not, the WTRU should start searching for another cell to camp on. This is very inefficient in terms of WTRU power consumption and latency.

In representative embodiments, a WTRU may determine a channel raster group (CRG) (e.g., a subset of channel rasters) to scan for an SSB in an operating frequency band based on one or more network-sided (NW-sided) conditions and/or one or more WTRU-sided conditions, wherein each channel raster group (CRG) may have different frequency granularity between adjacent channel rasters in the group, and/or different number of channel rasters. In some instances, the one or more network-sided conditions may comprise at least one of a target operator (e.g., public land mobile network identity (PLMN-ID)), a radio access technology type (RAT type) (e.g., 5G or 6G), and a target network type (target NW type) (e.g., terrestrial networks (TN), non-terrestrial networks (NTN)). In some instances, the one or more WTRU-sided conditions may comprise at least one of, a WTRU location, a zone identifier (zone-ID) and a WTRU capability.

In representative embodiments, a WTRU may be powered up. The WTRU may determine one or more network-sided conditions, such as target NW type (e.g., a TN or NTN), target operator (e.g., a PLMN-ID), and a RAT type (e.g., 5G or 6G)). Additionally or alternatively, the WTRU may determine one or more WTRU-sided conditions (e.g., WTRU location, zone-ID, capability). The WTRU may determine a CRG based on a target operating frequency band or channel bandwidth, one or more NW-sided conditions, and/or one or more WTRU-sided conditions, where an association between the CRG and the target frequency band, the one or more NW-sided conditions and the one or more WTRU-sided conditions is predefined and known by a next-generation Node B (gNB) and the WTRU. The WTRU may scan for an SSB over channel rasters belonging to the determined CRG.

In some representative implementations, a frequency granularity of a channel raster for an SSB scan (e.g., Sync raster step size) may be optimized per at least one of target operator, actual channel bandwidth, and region. This may significantly reduce WTRU power consumption. A channel raster may be used to indicate, from network (NW) to WTRU, one or more NW-sided conditions and/or one or more WTRU-sided conditions.

In some representative implementations, to reduce energy consumption at a WTRU to scan an excessive number of SSB frequency positions (e.g., Sync raster entries), a Sync raster step size may be different based on other system parameters, such as a geographical region, a WTRU location, a use case, one or more target cell types, etc.

Herein, SSB reference frequency positions may be referred to as reference frequency locations, wherein synchronization signal may be transmitted, monitored or scanned by a WTRU within an operating frequency band. A SSB reference frequency position may be interchangeably used with one of, e.g., a Sync raster, a Sync raster entry, a Sync raster frequency location, a candidate Sync raster location, a Sync raster index, a GSCN index, a GSCN, and a Sync raster position.

Herein, a Sync raster step size may be referred to as a frequency gap between adjacent SSB frequency positions where SSB may be transmitted, monitored or scanned by a WTRU. A Sync raster step size may be interchangeably used with one of, e.g., a frequency step size, a frequency gap, a minimum gap between SSB frequency positions, a frequency gap between SSB frequency positions, a frequency gap between Sync raster entries, a Sync raster frequency granularity, a Sync raster granularity, and a frequency gap between adjacent Sync raster entries.

Channel raster frequency location may be interchangeably used with one of, e.g., a Channel raster, a Channel raster reference location, and a Channel raster frequency. Channel rasters may be referred to as multiple Channel raster frequency locations.

Herein, a raster (e.g., a Channel raster, a Sync raster, any new type of rasters) may be a reference frequency, where a channel or signal may be transmitted by a network and/or a channel or signal may be monitored, measured, scanned, decoded, or detected by a WTRU which may assume or know that the channel or signal may be transmitted in the reference frequency. Whilst the term ‘raster’ may mean a set of frequencies, it may alternatively mean a single frequency. In the latter case, the term ‘raster group’ may be used to mean a set of frequencies.

A channel or signal associated with a raster may be predefined. Additionally or alternatively, the channel or signal associated with the raster may be configured and known by a network and a WTRU.

Herein, the network may be referred to as Node-B (NB), evolved NodeB (eNB), gNB, base station (BS), cell, serving cell, etc.

In some representative implementations, a channel raster may be defined or used as a reference frequency (e.g., at least a subset of global reference frequencies), wherein at least a subset of physical channels or signals, e.g., a start, middle, or end of a frequency resource allocated for a physical channel or signal, may be transmitted. The start, middle, or end of the frequency resource allocated for the physical channel or signal may be a subcarrier location of the channel or signal if an orthogonal frequency-division multiplexing (OFDM)-based waveform is used. If an even number of subcarriers is used for a channel or signal, the middle may be one subcarrier next to the half number of subcarriers. For example, for a channel or signal with 124 subcarriers, 62 subcarriers will be half of the subcarriers and a middle subcarrier may be either 61st subcarrier or 63rd subcarrier of the channel or signal, and a Sync raster may be defined as a reference frequency, wherein the Sync signal (e.g., start, middle, or end of the frequency resource of Sync signal) may be transmitted. The Sync signal may be an SSB, SS/PBCH block, or a Synchronization signal, where a WTRU may identify a physical cell identifier (cell ID), a system frame number (SFN number), a slot boundary, a subframe boundary, TTI boundary, a symbol boundary, a Cyclic Prefix (CP) length, a subcarrier spacing, a waveform and/or determine a time/frequency synchronization.

In some representative implementations, a subset of Channel rasters may be defined, determined, or used as a CRG. One or more Channel rasters in the CRG may be a reference frequency location wherein one or more channels or signals set out below may be transmitted by a network and/or monitored, scanned by a WTRU.

In one example of a channel or transmitted or scanned signal, a Sync signal for an initial cell search and/or a SS/PBCH block may be used or received by the WTRU to determine whether a cell is available to camp on. In this case, the CRG may be determined or used as a Sync raster.

In another example of a channel or transmitted or scanned signal, a discovery signal may be a reference signal or a sequence indicating an identification of a transmitter (e.g., a cell, a small cell, a transmission and reception point (TRP), a reference WTRU, a reference point, a positioning reference unit, a TN cell, or a NTN cell). The WTRU may scan the discovery signal in the subset of Channel rasters (e.g., signal rasters) associated with the discovery signal; and identify, determine, search a target transmitter. The discovery signal may be used to indicate an existence of a cell a WTRU may be looking for.

In yet another example of a channel or transmitted or scanned signal, a wake-up signal may indicate some information related to the network (including one or more NW-sided conditions and/or configuration) to the WTRU, or trigger one or more subsequent WTRU behaviors.

In some examples, the Wake-up signal (WUS) may have a different waveform from other types of signals (e.g., for communication such as an SSB, physical downlink control channel (PDCCH), physical downlink shared channel (PDSCH), Physical Uplink Control Channel (PUCCH), Physical Uplink Shared Channel (PUSCH), etc.).

In some examples, the WUS may be targeted or received by the WTRU with a respective receiver. For example, the WTRU may use a low power receiver (hereinafter referred to as LR) for the WUS and a main receiver (hereinafter referred to as MR) for other types of signals used for data transmission/reception (e.g., SSB, PDCCH, PDSCH, PUCCH, PUSCH, channel state information reference signal (CSI-RS), demodulation reference signal (DM-RS), positioning reference signal (PRS), tracking reference signal (TRS), etc.).

In some examples, one or more WUS types may be used based on an indication of different types of one or more NW-sided conditions and/or configuration. For example, a first WUS type may be used to indicate a first type of the one or more NW-sided conditions (e.g., NW capability-related information) and a second type of one or more NW-sided conditions (e.g., RAT related information).

In some representative embodiments, one or more CRGs may be used to determine a reference frequency location for an uplink transmission. For example, the one or more CRGs may be predefined, configured, indicated, or known to a WTRU and the WTRU may be allowed or determine to transmit one or more following signals on the frequency locations associated with a CRG, wherein the signals associated with the CRG. For example, the WTRU may be allowed to transmit the set of signals and/or channels associated with a CRG on the Channel rasters within the CRG.

In some examples, a first set of signals (and/or channels) may be associated with a first CRG and a second set of signals (and/or channels) may be associated with a second CRG.

In some examples, the WTRU may be allowed, determined, initiated, or triggered to transmit a signal or channel in one or more Channel raster locations in a first CRG in a first direction (e.g., uplink, sidelink) until the WTRU receives a targeted signal or channel in another Channel raster location in a second CRG in a second direction (e.g., downlink, sidelink) wherein the signal or channel in a first direction may be at least one of a wake-up signal, low-power wake-up signal (WUS), on-demand signal, a request signal (e.g., which may trigger a downlink channel), or a signal transmission. In such cases, the WUS and/or an on-demand signal may be used to request a transmission of one or more signals, e.g., Sync signal, SSB, one or more system information blocks (SIBs), SIB-x, discovery signal, tracking reference signal (TRS), and/or PDCCH for an uplink transmission (e.g., uplink (UL) grant, resource for a sounding reference signal (SRS) transmission, resource for PUCCH transmission).

In some examples, a Channel raster in the first CRG may have one or more associated Channel raster(s) in a second CRG. If the WTRU transmitted a signal or channel over a first Channel raster in the first CRG, the WTRU may attempt to receive, monitor, scan, or decode a corresponding signal or channel (e.g., requested signal and/or channel) over one or more second Channel rasters in the second CRG. Then, if the WTRU does not receive a corresponding signal or channel (e.g., a requested signal and/or channel) over one or more second Channel rasters, the WTRU may perform or attempt at least one of (i) re-transmit a signal or channel over a next Channel raster in the first CRG, wherein the next Channel raster may be predefined, configured, or indicated, and (ii) re-transmit a signal or a channel with a higher transmission power. With respect to (i), an order of Channel raster to use in CRG may be pre-defined, configured, indicated, or used.

In some examples, one or more transmission characteristics may be pre-configured, pre-defined, configured, or indicated per CRG, wherein the one or more transmission characteristics include at least one of (i) a transmission power (e.g., transmission power of each attempt), (ii) a reference time (e.g., a timing associated with a global time, a global navigation satellite systems (GNSS), etc.), and (iii) a cyclic prefix (CP) length (if a signal or channel is based on OFDM waveform).

In some representative embodiments, one or more NW-sided conditions may comprise at least one of (i) an operating frequency band, (ii) an operating bandwidth, (iii) a channel bandwidth, (iv) network operator related information (e.g., a PLMN identity), (v) cell-related information, (vi) cell barring related information, (vii) network (NW) capability related information, (vii) RAT related information, (viii) transmitter (e.g., a gNB, TRP, satellite, anchor WTRU) geographical information, (ix) a NW type, (x) a NW radio capability, (xi) NW mode of operation, (xii) NW energy saving status, (xiii) NW traffic load status (e.g., high, medium or low); (xiv) broadcasting channel transmission type, (xv) radio access network (RAN) sharing status (e.g., whether RAN sharing across multiple operators are used or not), and (xvi) SSB type.

In cases in which the NW-sided condition comprises the operating frequency band, the operating frequency band may indicate a frequency bandwidth, a frequency region, an absolute frequency, etc.

In cases in which the NW-sided condition comprises the operating bandwidth, the operating bandwidth may comprise the frequency resource used, configured, determined for a certain operation such as default bandwidth part (BWP) which may be used for initial access, default operation, fallback operation, BWP used for common channel transmission (e.g., SSB, paging, SIB, PDCCH common search space).

In cases in which the NW-sided condition comprises a channel bandwidth, the Channel bandwidth may comprise, e.g., an actual channel bandwidth used by an operator within an operating frequency band.

In cases in which the NW-sided condition comprises cell related information, the cell related information may comprise for example, a physical cell identity, a global cell identity, etc.

In cases in which the NW-sided condition comprises cell-barring related information, the cell barring related information may comprise at least one of, e.g., supported WTRU types, WTRU categories, WTRU types and WTRU capabilities (for example, not allowed for camping on the cell).

In cases in which the NW-sided condition comprises NW capability related information, NW capability related information may comprise at least one of, e.g., (i) support and/or activation of WTRU power saving mode (e.g., wake up signal, PDCCH skipping, UL skipping, etc.), (ii) support of low-layer triggered mobility (LTM), (iii) support of a specific service (e.g., broadcasting, positioning, sensing, AI/ML, etc.).

In cases in which the NW-sided condition comprises RAT related information, RAT related information may comprise at least one of (i) support and/or deployment of generation (4G, 5G, 6G, etc.), and (ii) support of multi-RAT spectrum sharing (MRSS) with one or more generation (e.g., 4G, 5G, and 6G).

In cases in which the NW-sided condition comprises transmitter geographical information, the transmitter geographical information may comprise, e.g., a country, a zone.

In cases in which the NW-sided condition comprises NW type, the NW type may comprise, e.g., TN or NTN.

In cases in which the NW-sided condition comprises NW radio capability, the NW radio capability may comprise at least one of, e.g., a number of antennas, an active number of antennas, a transmission power, a number of beams, a beamwidth, and a beam footprint, latency.

In cases in which the NW-sided condition comprises NW mode of operation, the NW mode of operation may comprise at least one of, e.g., a network energy saving mode, a normal energy mode, etc.

In cases in which the NW-sided condition comprises NW energy saving status, the NW energy saving status may comprise at least one of, e.g., an on/off Cell-discontinuous transmission (DTX)/discontinuous reception (DRX), a cell-DTX/DRX configuration, etc.

In cases in which the NW-sided condition comprises a broadcasting transmission type, the broadcasting channel transmission type may comprise at least one of, e.g., an on-demand SSB, an on-demand SIB1, an on-demand SIBx, always on SSB, always on SIB1, etc. When a WTRU identifies a broadcasting channel transmission type, if it is based on on-demand, the WTRU may request, in the pre-configured, or configured uplink resource, a signal or channel.

In cases in which the NW-sided condition comprises SSB type, the SSB type may comprise one of, e.g., Cell-defining SSB (CD-SSB), or Non-cell-defining SSB (NCD-SSB), wherein the CD-SSB may include valid MIB information in the PBCH while the NCD-SSB may include invalid MIB information. In some examples, the valid MIB information may be a MIB information a WTRU can use and the invalid MIB information may be a MIB information the WTRU cannot use for a subsequent transmission or for identifying a cell configuration.

In some representative embodiments, one or more WTRU-sided conditions may comprise at least one of (i) geographical location related information associated with a WTRU, (ii) a target operator identity (e.g., a PLMN-ID), (iii) WTRU channel conditions, (iv) WTRU mobility conditions, (v) WTRU capabilities, (vi) a WTRU device status, and (vii) a WTRU network connection status.

The term ‘WTRU-sided condition’ may be interchangeably used with any one of terms ‘WTRU-sided configuration’, ‘WTRU-sided situation’, ‘WTRU-sided channel condition’, ‘WTRU-sided information’, ‘WTRU-sided status’ and the like.

In cases in which the WTRU-sided condition comprises the WTRU's geographical location related information, the geographical location related information associated with the WTRU may comprise at least one of, e.g., a zone-ID, a cell-ID, a TRP-ID, an anchor UE identity. The geographical location related information associated with the WTRU may be acquired by the WTRU based on at least one of, e.g., positioning information, a zone defined, a cell (for example, the WTRU currently camp on or previously camped on) and TRP (for example, the WTRU currently camp on or previously camped on) and an anchor WTRU with which a WTRU is currently communicating or previously communicated.

In cases in which the WTRU-sided condition comprises WTRU channel conditions, the WTRU channel conditions may comprise at least one of, e.g., a reference signal received power (RSRP) level, a signal to interference plus noise ratio (SINR) level, a frequency selectivity level, a line-of-sight (LoS) probability, indoor/outdoor, cell center or cell edge, etc.

In cases in which the WTRU-sided condition comprises WTRU mobility conditions, the WTRU mobility conditions may comprise, e.g., a WTRU speed, a moving direction of the WTRU, a handover frequency of the WTRU).

In cases in which the WTRU-sided condition comprises WTRU capabilities, the WTRU capabilities may comprise at least one of, e.g., a number of Transmission/Reception (Tx/Rx) antennas, a supporting frequency bandwidth for downlink and/or uplink, a device type, WTRU categories, a support of low power receiver, a maximum transmission power, a supporting feature group, supporting functionalities, etc.

In cases in which the WTRU-sided condition comprises WTRU device status, the WTRU device status may comprise at least one of, e.g., a remaining battery level, a device temperature, etc.

In cases in which the WTRU-sided condition comprises WTRU network connection status, the WTRU network connection status may comprise one of, e.g., radio resource control (RRC) connected, RRC idle or RRC inactive.

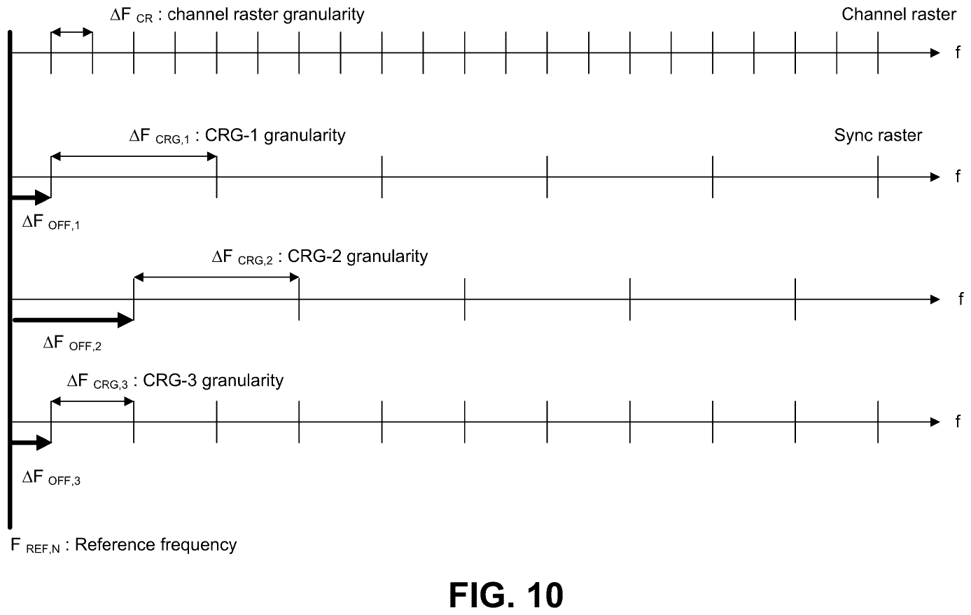

FIG. 10 illustrates how a CRG may be defined, determined, indicated, or configured based on at least one of, e.g., a channel raster granularity, a reference frequency (F_{REF,N}), a start offset (ΔF_{OFF}) from the reference frequency, and a channel raster group (CRG) granularity. The reference frequency may be predefined, configured, determined or indicated based on one or more network-sided conditions and/or one or more WTRU-sided conditions, wherein each Channel raster may be associated with an index, e.g., Global Channel Raster Index (GCRI) and a subset of GCRIs may be determined to form a CRG (e.g., CRG-x=GCRI (N:k:M), wherein CRG number x includes every k-th GCRI number from N to M. In some examples, N and M may be determined based on operating frequency band number (e.g., n41, n51, etc.). In some examples, k may be determined, configured, or indicated based on at least one of, e.g., CRG number, a CRG type, and a CRG identity.

In some representative embodiments, one or more types of CRGs may be used, defined, or configured, wherein a CRG type may be determined based on at least one of (i) a transmission direction of the signal or channel associated with the CRG, (ii) associated channel types, (iii) associated spectrum usages, (iv) standalone spectrum or shared spectrum, (v) licensed spectrum or unlicensed spectrum, (vi) User-to-user operation or sidelink operation, (vii) a network type, (viii) associated Channel raster frequency granularity, (ix) associated RAT type, (x) associated SSB type, (xi) associated system parameters, (xii) one or more network-sided conditions, (xiii) one or more WTRU-sided conditions, and (xiv) associated PBCH type.

The term ‘CRG type’ may be interchangeably used with any one of terms ‘CRG’, ‘CRG identity’, and ‘CRG number’.

In cases where the CRG type is determined based on the transmission direction of the signal or channel associated with the CRG, a first type of CRGs may be associated with signals and/or channels in downlink, wherein a WTRU may scan one or more Channel rasters in the CRG type to identify, detect, or search a target downlink signal (e.g., SSB, discovery signal, WUS, etc.). Additionally or alternatively, a second type of CRGs may be associated with uplink, wherein the WTRU may transmit an uplink signal in one or more Channel rasters in the CRG type to trigger or request a signal or channel in another transmission direction (e.g., downlink channel including SSB, SIB1, SIB-x, and/or WUS). Additionally or alternatively, a third type of CRGs may be associated with sidelink, wherein the WTRU may transmit a sidelink signal in one or more Channel rasters in the CRG type to trigger or request a signal or channel on the same Channel raster (or Channel rasters in the same CRG types) at a later time.

In cases where the CRG type is determined based on the associated channel types, a first CRG type may be associated with a first set of channels and signals used for initial access, mobility, and idle mode procedures (e.g., SSB, discovery signal, paging); and a second CRG type may be associated with a second set of channels and signals used for communications (e.g., control and data channels).

In cases where the CRG type is determined based on the associated spectrum usages, the associated spectrum type may be at least one of (i) a standalone spectrum or shared spectrum, (ii) a licensed spectrum or unlicensed spectrum, (iii) a user-to-user (Uu) operation or sidelink operation, and (iv) a network type.

In cases where the CRG type is determined based on standalone spectrum or shared spectrum, standalone spectrum may be referred to as a spectrum used by a single RAT (e.g., 4G, 5G, 6G), and the shared spectrum may be referred to as a spectrum shared by multiple RATs (e.g., 5G and 6G) including but not limited to spectrum sharing in time and/or frequency.

In cases where the CRG type is determined based on licensed spectrum or unlicensed spectrum, the unlicensed spectrum may be referred to as a spectrum where uplink and/or downlink transmission with sensing operation (e.g., LBT).

In cases where the CRG type is determined based on user-to-user (Uu) operation or sidelink operation, the Uu operation may be a spectrum used for communication between a gNB and a WTRU, and the sidelink operation may be a spectrum used for communication between a WTRU and a WTRU (or device).

In cases where the CRG type is determined based on a network type, the network type may be referred to as TN, wherein the gNB may be located on the ground. In some examples, the network type may be referred to as NTN, wherein the gNB may be located above the ground (e.g., HAPS, satellite, etc.).

In cases where the CRG type is determined based on the associated Channel raster frequency granularity, a first CRG type may be associated with a first Channel raster frequency granularity and a second CRG type may be associated with a second Channel raster frequency granularity.

In cases where the CRG type is determined based on associated RAT type, a first CRG type may be associated with a first RAT (e.g., 5G NR); a second CRG type may be associated with a second RAT (e.g., 6G); a third CRG type may be associated with a third RAT (e.g., MRSS 5G+6G); a fourth CRG type may be associated with a fourth RAT (e.g., DSS 4G+5G).

The Channel rasters in a CRG may be referred to as channel rasters when they are used for or associated with a first RAT (e.g., 4G); the Channel rasters in a CRG may be referred to as Sync rasters when the Channel rasters are used for or associated with a second RAT (e.g., 5G); the Channel rasters in a CRG may be referred to as adaptive Sync rasters when the Channels rasters are used for or associated with a third RAT (e.g., 6G).

In cases where the CRG type is determined based on an associated SSB type, one or more of SSB types may be defined and/or used, wherein each SSB type may have a respective structure (e.g., number of symbols, number of subcarriers, etc.). When a WTRU scans a respective SSB type, the WTRU may use the Channel rasters within the CRG associated with the SSB type.

In cases where the CRG type is determined based on associated system parameters, the associated system parameters may comprise at least one of, e.g., (i) a waveform of a system, (ii) a numerology of the waveform, wherein the waveform of the system may comprise one of, e.g., discrete fourier transform-spread-orthogonal frequency division multiplexing (DFT-S-OFDM DFT-s-OFDM) or OFDM. The numerology of the waveform may comprise at least one of, e.g., a subcarrier spacing, a CP length, and a slot length.

In cases where the CRG type is determined based on associated PBCH type, one or more PBCH types may be defined and/or used, and a WTRU may determine a PBCH type based on an associated CRG number, wherein each PBCH type may have following characteristics. For example, a first PBCH type may have a first time/frequency resources relative to synchronization signal (e.g., subcarrier offset), a first set of MIB contents which may be carried in the PBCH, and/or a first demodulation reference signal (DM-RS) locations, pattern, overhead, and/or sequences. A second PBCH type may have a second time/frequency resources relative to synchronization signal, a second set of MIB contents, and/or a second DM-RS locations, pattern, overhead, and/or sequences.

Channel rasters in one or more CRG types or CRGs may be non-overlapped, fully overlapped, or partially overlapped. When a Channel raster belongs to more than one CRG, a WTRU may assume that union of channels or signals associated with the Channel raster may be transmitted or received over the Channel raster.

In some representative embodiments, one or more CRGs may be used, defined, pre-configured, or pre-determined for an operating frequency band, and/or channel bandwidth within an operating frequency band. The one or more CRGs may have respective associated priority. For example, {CRG-1, CRG-2, CRG-3} may be pre-defined, configured, or determined for a frequency operating band nXY, and a priority order of the CRGs may be determined based on at least one of (i) one or more NW-sided conditions and/or one or more UE-sided conditions, (ii) geographical location (e.g., zone-id, country, region) associated with a WTRU, (iii) a frequency range (e.g., FR1, FR2, FR3), (iv) an associated NTN cell (e.g., wherein one or more TN cells may be associated with the NTN cell), (v) a target cell (e.g., TN cell or NTN cell), and (vi) a target operator identity (e.g., PLMN-id).

In some instances, a WTRU may scan Sync rasters associated with a higher priority CRG and if the WTRU could not find a target cell (or a cell) to camp on, the WTRU may scan Sync rasters associated with a next highest priority CRG, and so forth. In this case, a higher priority CRG may have a smaller number of Sync rasters to scan than that of a lower priority CRG.

In some instances, one or more CRGs and a respective priority order associated with each of the one or more CRGs may be provided, from a network, to a WTRU for a target cell following a request from the WTRU.

In some representative implementations, a WTRU may determine one or more NW-sided conditions based on a channel raster location, wherein the WTRU successfully received a targeted channel (e.g., a SSB, discovery signal, a wake-up signal, a broadcasting signal (e.g., master information block (MIB), system information block (SIB)), a reference signal (e.g., a tracking reference signal (TRS), a channel state information reference signal (CSI-RS)), a control channel (e.g., physical downlink control channel (PDCCH)).

Based on the one or more determined NW-sided conditions, the WTRU may monitor or receive a subsequent signal or channel associated with the one or more determined NW-sided conditions, wherein one or more characteristics of the subsequent signal or channel may be determined based on the one or more determined NW-sided condition.

The one or more signal or channel characteristics may comprise at least one of (i) a numerology (e.g., a subcarrier spacing, a CP length, a TTI length), (ii) a physical channel configuration (e.g., a number of symbols, a number of subcarriers, a reference signal structure, a reference signal overhead), (iii) a coverage level (e.g., number of repetitions of the signal or channel), (iv) a SSB type, (v) a SSB configuration (e.g., a periodicity, a number of SSBs, a distance between SSBs), and (vi) a Duplex mode (e.g., subband full duplex (SBFD), non-subband full duplex (non-SBFD)).

In certain embodiments, a WTRU may indicate or report its capability by sending an uplink signal or channel by using uplink resource associated with a channel raster (e.g., DL channel raster or UL channel raster), wherein DL channel raster may be referred to as a channel raster in CRG used for DL reception and UL channel raster may be referred to as a channel raster in CRG used for UL transmission.

A WTRU may use one or more channel rasters in a CRG which is applicable to the WTRU-sided condition. Based on the reception of a signal or a channel from associated with the CRG, gNB may receive or acknowledge WTRU-sided condition (e.g., WTRU capability, WTRU category, etc.)

In certain representative embodiments, a NW may indicate one or more CRGs for a frequency resource which is not currently allocated or used, wherein the frequency resource may be a frequency carrier which may be not overlapped with a current serving carrier. The serving carrier may be referred to as a carrier wherein the WTRU received information related to the one or more CRGs.

The frequency carrier may be an operating frequency band used for another type of NW from the serving cell. For example, a WTRU may receive one or more CRGs from NTN cell for an operating frequency band allocated or used for a TN cell.

A NW (e.g., TN cell or NTN cell) may provide information related to initial cell search for another cell (e.g., another type of network, if serving cell is TN cell, another type of network may be referred to as NTN cell) to reduce WTRU battery consumption for the cell search.

In certain representative embodiments, a WTRU may receive a signal (e.g., broadcasting signal, SIB, or MIB) from an operator (e.g., a first PLMN-id) and the signal may include CRG information for the target operator (e.g., a second PLMN-id) in the same operating frequency band and/or a different operating frequency band. One or more of following may apply:
The broadcasting signal may include a set of information including one or more of operating frequency band, its associated CRG and PLMN-id.

The signal may be a dedicated signal, and the WTRU may request the signal to the network.

In certain representative embodiments, one or more operators may share an SSB (e.g., RAN sharing) in an operating frequency band and the SSB may be scanned by a WTRU using a CRG. Hereafter, the SSB shared by multiple operators may be referred to as shared SSB. One or more of following may apply:
A CRG for the shared SSB may be pre-defined, or pre-configured per operating frequency band and/or its associated channel bandwidth.

A WTRU may first receive the shared SSB, wherein PBCH may include operator-specific (e.g., PLMN-id specific) cell search information (e.g., frequency resource, e.g., BWP for the operator, its associated CRG for the SSB used for the operator, e.g., dedicated SSB).

Sync raster step size may be referred to as a frequency granularity between adjacent Sync rasters. Sync raster step size may be interchangeably used Sync raster granularity (SRG), Sync raster gap, Sync raster distance, and Sync raster sparsity. Herein, a Channel raster may be a Sync raster if a synchronization signal may be transmitted over the Channel raster. When a CRG is associated synchronization signal, the Channel rasters in the CRG may be considered as Sync rasters and the Channel raster granularity may become Sync raster granularity.

In certain representative embodiments, Sync rasters may be located within an operating frequency band (and/or channel bandwidth) with equal frequency spacing (i.e., Sync raster granularity (SRG)) from a starting frequency to an end frequency, wherein the starting frequency and the end frequency may be within the operating frequency band (or channel bandwidth).

In some cases, the starting frequency, the ending frequency, and/or SRG may be a reference frequency determined based on NW-sided conditions and/or UE-sided conditions.

In some cases, SRG may be determined based on at least one of: i) Operating frequency band index, ii) Channel bandwidth within the operating frequency band, wherein the channel bandwidth may be actual frequency bandwidth used by an operator (e.g., PLMN-id) and it may be equal to or smaller than operating frequency band, iii) one or more of operating frequency band, channel bandwidth, channel bandwidth index, gNB location, UE location, PLMN-id, zone-ID where UE and/or gNB located, NW-sided condition, and UE-sided conditions, and iv) minimum or maximum channel bandwidth supported within the operating frequency band.

In cases in which the SRG is determined based on channel bandwidth within the operating frequency band, channel bandwidth within an operating frequency band for an operator (e.g., same PLMN-id) may be different based on the gNB location and/or UE location, and one or more Channel bandwidths may be used, defined, or configured, and each Channel bandwidth within an operating frequency band may be associated with an index.

In certain embodiments, SRG may be configured or predetermined per CRG (Channel raster group). For example, one or more CRGs may be predefined, predetermined, configured, or indicated for an operating frequency band, wherein each CRG associated with an SRG. A first CRG may be associated with a first SRG and a second CRG may be associated with a second SRG, wherein the first SRG may be smaller or larger than the second SRG. A first CRG may be associated with a smaller channel bandwidth and a second CRG may be associated with a larger channel bandwidth. In this case, the SRG for a first CRG may be smaller than the SRG for a second CRG.

In certain representative embodiments, for an operating band (or a channel bandwidth within the operating band), a set of Sync rasters may be predefined, configured, or used for multiple RATs, wherein the set of Sync rasters shared by multiple RATs may be referred to as Shared Sync Raster (SSR). A WTRU targeting a first RAT (e.g., 5G) may scan all Sync rasters within SSR to detect a Sync signal while a WTRU targeting a second RAT (e.g., 6G) may scan a first subset of SSR with a first priority and if the WTRU doesn't detect any Sync signal, the WTRU may scan a second subset of SSR with a second priority and so forth until it detects a Sync signal for a cell the WTRU may camp on.

Herein, SSR may be interchangeably used with Sync raster set which may be used for a RAT.

In some examples, a WTRU may determine a set of Sync rasters for a Channel bandwidth in an operating band and the WTRU may determine priority of the Sync rasters. The WTRU scan Sync rasters based on the priority order. The WTRU first scan the first priority Sync rasters in the Channel bandwidth, if the WTRU fails to detect any valid Sync signal in the first priority Sync rasters, the WTRU may scan the second priority Sync rasters and so on.

The priority of Sync rasters within the set may be predefined, configured, or indicated. The priority of Sync rasters may be determined based on target operator (e.g., PLML-id), the WTRU's geographical location (e.g., country, region, zone-ID), associated NTN cell (e.g., when a WTRU is connected NTN cell and the WTRU tries to find TN cell within the NTN cell coverage), NW-sided condition, and/or WTRU-sided condition.

The priority of Sync rasters may be indicated or configured by a network (e.g., network previously connected, or network with non-target operator or cell.

A WTRU may determine whether to scan the full Sync rasters of SSR or a subset of SSR based on target RAT (e.g., 4G, 5G, or 6G).

For a channel bandwidth (or operating band), a set of Sync rasters may be used, and a subset of the Sync rasters may be identified or determined as SSR.

In this case, a WTRU may prioritize to scan Sync rasters within SSR if the WTRU may support one or more RATs associated with SSR and/or if the WTRU may not have a specific target RAT. Alternatively, if a WTRU has a target RAT (e.g., WTRU only has data plan for a specific RAT only, e.g., 5G), the WTRU may scan all Sync rasters within the channel bandwidth without priority.

In an operating band or channel bandwidth determined, defined, or identified as MRSS band, a WTRU may prioritize to scan Sync rasters within SSR.

In certain representative embodiments, when a WTRU detects a Sync signal on a Sync raster within SSR, the Sync signal detected may be shared for one or more RATs (e.g., 5G and 6G) or the Sync signal may be associated with a first RAT (e.g., 5G or 6G). In this case, one or more of following may apply:
Sync signal may be shared and RAT-specific SSB may be transmitted in a different time location. For example, a first time and/or frequency gap (e.g., time and/or frequency gap from the Sync signal detected) may be used for the start of the transmission of one or more SSBs for a first RAT (e.g., 5G) and a second time and/or frequency gap may be used for the start of the transmission of one or more SSBs for a second RAT (e.g., 6G). If a WTRU is targeting a first RAT, the WTRU may scan the RAT-specific SSB based on the time and/or frequency gap.

The time and/or frequency gap may be predefined, configured, or determined based on NW-sided condition.

One or more time and/or frequency gaps may be used for a RAT as a candidate timing and frequency of RAT-specific SSB.

The Sync signal shared by one or more RATs may indicate a set of time and/or frequency gaps (e.g., time and/or frequency gaps for a first RATs and time and/or frequency gaps for a second RATs) based on associated Sync signal sequence. For example, a first Sync signal sequence may indicate a first set of time and/or frequency gaps, and a second Sync signal sequence may indicate a second set of time and/or frequency gaps.

The time gap may be in the unit of seconds, number of OFDM symbols with a specific subcarrier spacing or subcarrier spacing detected from the Sync signal, number of slots, etc.

The frequency gap may be in the unit of Sync rasters, number of subcarriers, and/or number of RBs.

The term gap may be interchangeably used with offset, distance, and/or delta value.

In certain representative embodiments, one or more types of Sync rasters may be defined, pre-configured, or determined. For example, a first type of Sync raster may be a Sync raster shared with another RAT and/or a Sync raster overlapped with another Sync raster used for another RAT; a second type of Sync raster may be a Sync raster dedicated for the RAT. One or both of following may apply:
The first type of Sync rasters may be used, identified, or determined as cell-defining SSB (e.g., PBCH information is used by the WTRU), and the second type of Sync raster may be used, identified, or determined as non-cell-defining SSB (e.g., PBCH information is not used by the WTRU).

The first type of Sync rasters may be scanned by a first type of WTRU and the second type of Sync rasters may be scanned by a second type of WTRU, wherein the type of WTRU may be determined based on one or more of WTRU-sided conditions (e.g., WTRU capability).

In some embodiments, a WTRU determines a channel raster group (CRG) (e.g., a subset of channel rasters) to scan for an SSB in an operating frequency band (or channel bandwidth) based on at least one of NW-sided condition (e.g., PLMN-id, RAT type (5G or 6G), NW type (TN, NTN)), WTRU-sided condition (e.g., WTRU location, zone-ID, WTRU capability) or an indication from non-target RAT/network/cell (e.g., NTN cell may provide CRG information for TN cell).

In some embodiments, a Sync raster gap in CRG for an operating band may be determined based on one or more of minimum/maximum channel bandwidth, PLMN-id, WTRU's geographical location (e.g., country, region, zone-id) or an associated NTN cell.

In some embodiments, a priority of Sync rasters is used for an operating band, and a WTRU can use Sync rasters based on the priority order which may be determined based on whether a Sync raster is a shared Sync raster across multiple RAT or a dedicated Sync raster for a RAT.

In some embodiments, a WTRU may detect a shared Sync signal in a shared Sync raster, and may determines time/frequency offsets from the Sync signal to receive an SSB for a target RAT (e.g., 5G or 6G), wherein the time/frequency offset may be predefined or indicated by the Sync signal (e.g., Sync signal sequence).

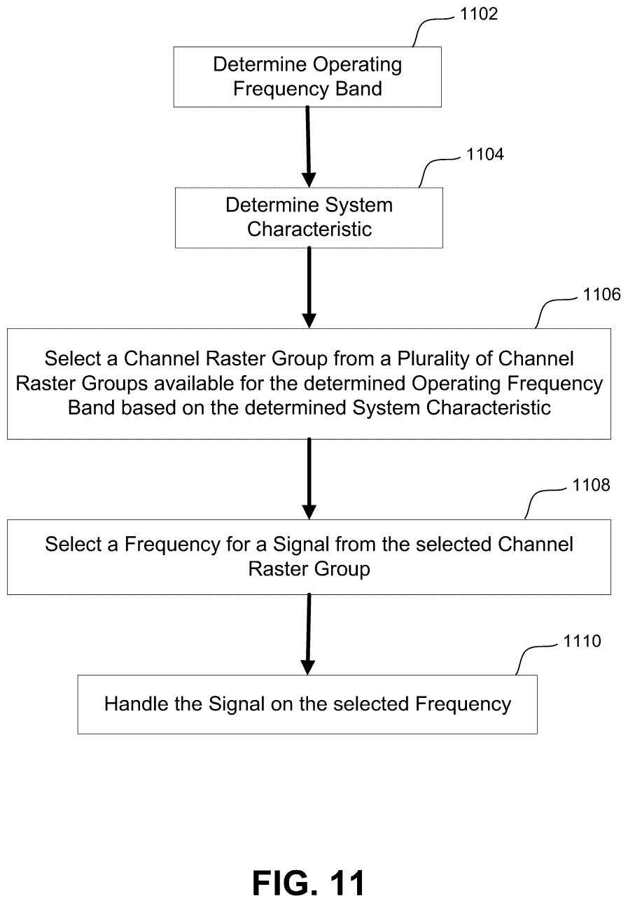

FIG. 11 illustrates a method performed by a WTRU according to an embodiment which may, for example, be performed when the WTRU is powered up or turned on. The method may begin with the WTRU determining 1102 an operating frequency band to be used by the WTRU. The WTRU may determine 1104 a system characteristic (for example, a network-sided characteristic or a WTRU-sided characteristic). The WTRU may then select 1106 a channel raster group from a plurality of channel raster groups available for the determined operating frequency band based on the determined system characteristic. Having selected a channel raster group, the WTRU may then select 1108 a frequency from the selected channel raster group for handling (e.g. transmitting or receiving) a signal. The WTRU may then handle 1110 the signal on the selected frequency.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

What is claimed is:

1. A method performed by a Wireless Transmit/Receive Unit (WTRU), the method comprising:
determining an operating frequency band;
determining a system characteristic;
selecting a channel raster group from a plurality of channel raster groups available for the determined target operating frequency band based on the system characteristic;
selecting a frequency for a signal from the selected channel raster group; and
handling the signal on the selected frequency.

2. The method of claim 1 wherein determining the operating frequency band comprises determining a channel bandwidth.

3. The method of claim 1 wherein the system characteristic comprises a network-side condition.

4. The method of claim 1 wherein the system characteristic comprises a WTRU-side condition.

5. The method of claim 1 wherein selecting the channel raster group from the plurality of channel raster groups based on the system characteristic comprises determining a reference frequency and a step size based on the system characteristic.

6. The method of claim 1 wherein selecting the frequency for the signal from the selected channel raster group comprises selecting the frequency for receiving the signal, and handling the signal on the selected frequency comprises receiving the signal on the selected frequency.

7. The method of claim 6 wherein the signal comprises a synchronization signal block (SSB).

8. The method of claim 6 further comprising:
determining a priority ordering of two or more channel raster groups;
selecting a higher priority channel raster group; and
subsequently selecting a lower priority channel raster group based on no desired signal being received on one or more frequencies in the higher priority channel raster group.

9. The method of claim 1 further comprising determining network-supplied information based on a channel raster group selected by a network.

10. The method of claim 1 wherein the plurality of channel raster groups are for respective different radio access technologies (RATs).

11. A Wireless Transmit/Receive Unit (WTRU) comprising:
a processor, and
a transceiver coupled to the processor, wherein the WTRU is configured to:
determine an operating frequency band;
determine a system characteristic;
select a channel raster group from a plurality of channel raster groups available for the determined target operating frequency band based on the system characteristic;
select a frequency for a signal from the selected channel raster group; and
handle the signal on the selected frequency.

12. The WTRU of claim 11, wherein the WTRU is configured to determine the operating frequency band by determining a channel bandwidth.

13. The WTRU of claim 11, wherein the system characteristic comprises a network-side condition.

14. The WTRU of claim 11, wherein the system characteristic comprises a WTRU-side condition.

15. The WTRU of claim 11, wherein the WTRU is configured to select the channel raster group from the plurality of channel raster groups based on the system characteristic by determining a reference frequency and a step size based on the system characteristic.

16. The WTRU of claim 11, wherein the WTRU is configured to select the frequency for the signal from the selected channel raster group by selecting the frequency for receiving the signal, and to handle the signal on the selected frequency by receiving the signal on the selected frequency.

17. The WTRU of claim 11, wherein the signal comprises a synchronization signal block (SSB).

18. The WTRU of claim 16, wherein the WTRU is further configured to:
determine a priority ordering of two or more channel raster groups;
select a higher priority channel raster group; and
subsequently select a lower priority channel raster group based on no signal being received on one or more frequencies in the higher priority channel raster group.

19. The WTRU of claim 16, wherein the WTRU is further configured to determine network-supplied information based on a channel raster group selected by a network.

20. The WTRU of claim 11, wherein the plurality of channel raster groups are for respective different radio access technologies (RATs).
